(19) United States
(12) Patent Application Publication
(10) Pub. No.: US 2002/0196764 A1
(43) Pub. Date: Dec. 26, 2002

(54) Method and system for authentication in wireless LAN system

(75) Inventor: Megumi Shimizu, Tokyo (JP)

Correspondence Address: McGinn & Gibb, PLLC, Suite 200, 8321 Old Courthouse Road, Vienna, VA, 22182-3817, US

(73) Assignee: NEC Corporation, Tokyo (JP)

(21) Appl. No.: 10/177,019

(22) Filed: Jun. 24, 2002

(30) Foreign Application Priority Data
Jun. 25, 2001 (JP) 191559/2001

(51) Int. Cl. H04Q 7/24

(52) U.S. Cl. 370/338; 370/349

(57) ABSTRACT

An STA retrieves an AP data management table held in it to check whether the MAC address of an AP it intends to make wireless communication with is in the table. When the MAC address is not present in the table, the STA makes a public key authentication request to the AP. When the MAC address is present in the table, the STA public key re-authentication request to the AP.

### BACKGROUND OF THE INVENTION

This application claims benefit of Japanese Patent Application No. 2001-191559 filed on Jun. 25, 2001, the contents of which are incorporated by the reference.

The present invention relates to method of and system for authentication in wireless LAN (local area network) system and, more particularly, to method of and system for authentication in wireless LAN system for wireless communication with encryption data, which permits simultaneous realization of confidential encryption key distribution and authentication only between opposite side parties of wireless communication.

In the wireless LAN system, encryption of data frames that are transmitted and received, is an essential requirement for ensuring the confidential property of transmitted and received data.

As for encryption system in the wireless LAN system, studies for standardization have been made mainly by Committee of IEEE (Institute of Electrical and Electronics Engineers) 802, and an IEEE 802.11 as a standard specification adopts a shared key authentication system as one of systems for encryption and authentication in wireless LAN radio section.

In the shared key system, an AP (access point) 1 as base station and STA (station) 2 as mobile terminal station, in the wireless LAN system as shown in FIG. 1, use one type of shared key which can be mutually held in each opposite party of communication. Alternatively, instead of holding one kind of shared key, four different kinds of shared keys are held as key data common to both parties, and one of these shared keys is selectively used in encryption frame communication. However, no encryption key distribution method is defined in IEEE 802.11, and actual fitting determines the method.

An authentication procedure in the shared key system will now be described with reference to FIGS. 10 and 11.

FIG. 10 is a view showing the authentication procedure in the shared key system. FIG. 11 is a view showing frame body parts of frame formats which are transmitted and received in the authentication procedure in the shared key system.

Referring to FIG. 10, for making an authentication request in the shared key system to the AP 1, the STA 2 transmits authentication frame 1 thereto (step S1). The frame body part of the authentication frame 1 has a form of (1) authentication frame 1 as shown in FIG. 11, and it is a frame with algorithm number 11-1-1 of “1” and also with transaction sequence number 11-1-2 of “1”. The algorithm numbers 11-1-1 to 11-4-1 are defined to be always “1” at the time of authentication in the shared key system.

When the AP 1 receives the authentication request transmitted from the STA 2 in the step S1, it transmits a random bit train of challenge text to the STA 2 (step S2). The authentication frame 2 has a form of (2) authentication frame 2 as shown in FIG. 11, and it is a frame with algorithm number 11-2-1 of “1” as noted above, with transaction sequence number 11-2-2 of “2” and further with a challenge text inserted in challenge text element 11-2-4.

When the STA 2 receives the authentication frame 2 transmitted in the step S2, it executes encryption, with one shared key, of the challenge text received from the AP 1 and ICV (integrity check value) corresponding to the result of computation of CRC 32 (cyclic redundancy code, 32 bits) with respect to the challenge text (step S3). The STA 2 then transmits, by using the authentication frame 3, the ciphered challenge text and ICV together with IV (initialization vector) as key data of the shared key that is used to the AP 1 (step S4). The authentication frame 3 has a form of (3) authentication frame 3 as shown in FIG. 11, and is a frame with algorithm number 11-3-1 of “1” as noted above, with transaction sequence number 11-3-2 of “3” and further with added IV 11-3-3, challenge text element (i.e., ciphered challenge text) 11-3-4 and ICV 11-3-5.

When the AP 1 receives the authentication frame 3 transmitted in the step S4, it deciphers the ciphered part of the received frame from the key data (i.e., IV 11-3-3) in the received frame by using the corresponding shared key. When the AP 1 confirms the identity of the received frame ICV (i.e., ICV 11-3-5) and the ICV computed from the result of deciphering and also the identity of the text obtained from the result of deciphering and the challenge text transmitted in the step S2 (that is, when these identities are confirmed in the step S5), it notifies the completion of authentication to the STA 2 by transmitting the authentication frame 4 thereto (step S6). The authentication frame 4 has a form of (4) authentication frame 4 as shown in FIG. 11, and it is a frame with algorithm number 11-4-1 of “1” as noted above, with transaction sequence number 11-4-2 of “4” and further with added status code 11-4-9. The status codes 11-1-9 to 11-4-9 as shown in FIG. 11 are data fields for notifying such content as success or failure of frame reception to the opposite party of communication.

In the operation as described above, the authentication procedure in the shared key system is completed. Subsequently, encryption frame communication using the shared key is made between the STA 2 and the AP 1.

As for the method of authentication and key distribution in the shared key system, a number of arts or means have heretofore been proposed. In one of such arts, resort is had to a third party (such as a key managing server) other than the opposite side parties participating in communication. In another one of such arts, confidential data are exchanged only between the opposite side parties of communication. As an example of the former art, Japanese Patent Laid-Open No. 2001-111544 discloses “Method of and System for Authentication in wireless LAN System. In this disclosed technique, encryption authentication is made with an authentication server by using a shared key which has been distributed and held by some means. As an example of the former art, Japanese Patent Laid-Open No. 11-191761 discloses “Method of and System for Mutual Authentication”. In this disclosed technique, the legal ness of public key is confirmed by using Diffie-Hellman key distribution algorithm.

In the above first-mentioned example as a system utilizing a key managing server, mobile terminal data are preliminarily stored in the key managing server, and a key distribution procedure and an authentication procedure should be executed separately. Therefore, the authentication procedure which involves encryption is complicated.

In the above second-mentioned example as an authentication procedure utilizing the key distribution algorithm, the key distribution and authentication, which are held confidential, can be made at a time only between the opposite side parties of communication. However, the authentication procedure is complicated, and computations involved require long time. Beside, when executing the authentication procedure afresh after authentication release in case when communication is interrupted due to a radio propagation environment trouble or the like, the same procedure as one that is taken at the time of the first authentication should be made once again, thus increasing overhead traffic other than intrinsic data communication.

### SUMMARY OF THE INVENTION

The present invention was made in order to improve the above circumstances, and it has an object of providing a method of and a system for authentication in a wireless LAN system, which permit realization of confidential procedures of key distribution for encryption and authentication at a time only between the opposite side parties of communication, and also permit simplification, for an STA (i.e., mobile terminal station) having completed the first authentication, the procedure of the second and following authentications with respect to the same AP (i.e., base station) after authentication release.

According to an aspect of the present invention, there is provided an authentication method in a wireless LAN system, wherein an STA (mobile terminal station) retrieves an AP data management table held in the STA for checking whether the MAC address of an AP (base station), which the STA intends to make communication with, is present in the AP data management table, and when the MAC address is not present in the AP data management table, makes a public key authentication request to the AP, when the public key authentication request is proper, the AP effects authentication for the STA, when the MAC address is present in the AP data management table, the STA makes a public key re-authentication request to the AP, and when the public key re-authentication request is proper, the AP makes authentication of the STA.

In the AP data management table the STA holds MAC addresses of APs having public key authentication completion result in the order of newer authentication completion results by making public key authentication requests. The AP holds an AP confidential key as its own confidential key, an AP public key as a public key corresponding to the AP confidential key and an AP user certificate as its own user certificate with the AP public key attached thereto, and the STA holds an STA public key as its own confidential key, an STA public key as a public key corresponding to the STA confidential key and an STA user certificate as its own user certificate with the STA public key attached thereto. The step of the public key authentication request from the STA to the AP is constituted by a pubic key authentication procedure, the public key authentication procedure comprising a step authentication request from the STA to the AP, a step of transmitting the AP user certificate from the AP having received the authentication request to the STA, a step, in which the STA having received the AP user certificate checks the AP user certificate, then produces a ciphered STA user certificate by ciphering the STA user certificate by using the AP public key attached to the AP user certificate and then transmits the ciphered STA user certificate, and a step, in which the AP having received the ciphered STA user certificate reproduces the STA user certificate by deciphering the ciphered STA user certificate with the AP confidential key, then checks the reproduced STA user certificate, then produces a ciphered shared key by ciphering the shared key produced by the AP by using the STA public key attached to the STA user certificate and notifying the authentication permission to the STA, wherein the STA having received the ciphered shared key reproduces the shared key by deciphering the ciphered shared key with the STA confidential key and uses the reproduced shared key for subsequent encryption frame transmission. The algorithm number of a frame body part in the MAC frame that is transmitted and received when the STA requests the public key authentication to the AP is number “n” other than “0” and “1”. The AP holds a public key management table, and in the public key management table MAC addresses of STAs which the AP has past authentication permission notification results to, the STA public keys of the STAs and shared keys which the AP has generated and issued at the time of authentication permission of the STAs are held in the order of newer authentication permissions. The public key re-authentication request from the STA to the AP is a public key re-authentication procedure, the re-authentication procedure comprising a step, in which the STA makes a re-authentication request to the AP, and a step, in which the AP having received the re-authentication request retrieves the public key management table held in the AP to check whether the MAC address of the STA having transmitted the public key management request is present in the table, and when it is found as a result of the check that the MAC address of the STA is present in the public key management table and also that the STA public key as public key corresponding to the MAC address is held in the table, the AP generates a new shared key as a new shared key designated with respect to the STA, generates a ciphered new shared key by ciphering the new shared key with the STA public key and notifying authentication permission to the STA by transmitting the ciphered new shared key thereto, and the STA having received the ciphered new shared key reproduces the new shared key by deciphering the ciphered new shared key with the STA confidential key for using the new shared key for subsequent encryption frame communication. The algorithm number of frame body part of the MAC frame received at the time the public key re-authentication request from the STA to the AP is a given number “m” other than “0”, “1”, and “n”.

According to another aspect of the present invention, there is provided an authentication system in a wireless LAN system comprising, an STA (mobile terminal station) which retrieves an AP data management table held in the STA for checking whether the MAC address of an AP (base station), which the STA intends to make communication with, is present in the AP data management table, and when the MAC address is not present in the AP data management table, makes a public key authentication request to the AP, when the AP data management table is present in the MAC address, makes a public key re-authentication request to the AP, and the AP which makes authentication of the STA when the public key re-authentication request is proper.

In the AP data management table the STA holds MAC addresses of APs having public key authentication completion result in the order of newer authentication completion results by making public key authentication requests. The AP holds an AP confidential key as its own confidential key, an AP public key as a public key corresponding to the AP confidential key and an AP user certificate as its own user certificate with the AP public key attached thereto, and the STA holds an STA public key as its own confidential key, an STA public key as a public key corresponding to the STA confidential key and an STA user certificate as its own user certificate with the STA public key attached thereto. In the step of the public key authentication request from the STA to the AP, an authentication request is made from the STA to the AP, the AP user certificate is transmitted from the AP having received the authentication request to the STA, the STA having received the AP user certificate checks the AP user certificate, then produces a ciphered STA user certificate by ciphering the STA user certificate by using the AP public key attached to the AP user certificate and then transmits the ciphered STA user certificate to the AP, the AP having received the ciphered STA user certificate reproduces the STA user certificate by deciphering the ciphered STA user certificate with the AP confidential key, then checks the reproduced STA user certificate, then produces a ciphered shared key by ciphering the shared key produced by the AP by using the STA public key attached to the STA user certificate and notifying the authentication permission to the STA, and the STA having received the ciphered shared key reproduces the shared key by deciphering the ciphered shared key with the STA confidential key and uses the reproduced shared key for subsequent encryption frame transmission. The algorithm number of a frame body part in the MAC frame that is transmitted and received when the STA requests the public key authentication to the AP is number “n” other than “0” and “1”. The AP holds a public key management table, and in the public key management table MAC addresses of STAs which the AP has past authentication permission notification results to, the STA public keys of the STAs and shared keys which the AP has generated and issued at the time of authentication permission of the STAs are held in the order of newer authentication permissions. The public key re-authentication request from the STA to the AP is a public key re-authentication procedure, the re-authentication procedure comprising a step, in which the STA makes a re-authentication request to the AP, and a step, in which the AP having received the re-authentication request retrieves the public key management table held in the AP to check whether the MAC address of the STA having transmitted the public key management request is present in the table, and when it is found as a result of the check that the MAC address of the STA is present in the public key management table and also that the STA public key as public key corresponding to the MAC address is held in the table, the AP generates a new shared key as a new shared key designated with respect to the STA, generates a ciphered new shared key by ciphering the new shared key with the STA public key and notifying authentication permission to the STA by transmitting the ciphered new shared key thereto, and the STA having received the ciphered new shared key reproduces the new shared key by deciphering the ciphered new shared key with the STA confidential key for using the new shared key for subsequent encryption frame communication. The algorithm number of a frame body part in the MAC frame that is transmitted and received when the STA requests the public key authentication to the AP is number “m” other than “0”, “1” and “n”.

Other objects and features will be clarified from the following description with reference to attached drawings.

### BRIEF DESCRIPTION OF THE DRAWINGS

FIG. 1 is a block diagram showing an embodiment of the authentication system in a wireless LAN system according to the present invention;

FIG. 2 is a detailed block diagram showing an example of the AP and STA in FIG. 1;

FIG. 3 is a view showing the configuration of the MAC frame transmitted and received between the AP and the STA at the authentication request time;

FIG. 4 is a view for explaining the public key management table held in the AP in the embodiment;

FIG. 5 is a view for describing AP data management table held in the STA in the embodiment;

FIG. 6 is a view showing the public key authentication procedure in the embodiment;

FIG. 7 is a view showing frame body part of the MAC frame transmitted and received in the public key authentication procedure in the embodiment;

FIG. 8 is a view showing the re-authentication procedure in the embodiment;

FIG. 9 is a view showing a frame body part of MAC frame transmitted and received in the public key re-authentication procedure in the embodiment;

FIG. 10 is a view showing the authentication procedure in the shared key system in the embodiment; and

FIG. 11 is a view showing frame body parts of frame formats which are transmitted and received in the authentication procedure in the shared key system in the embodiment.

### PREFERRED EMBODIMENTS OF THE INVENTION

Preferred embodiments of the present invention will now be described with reference to the drawings.

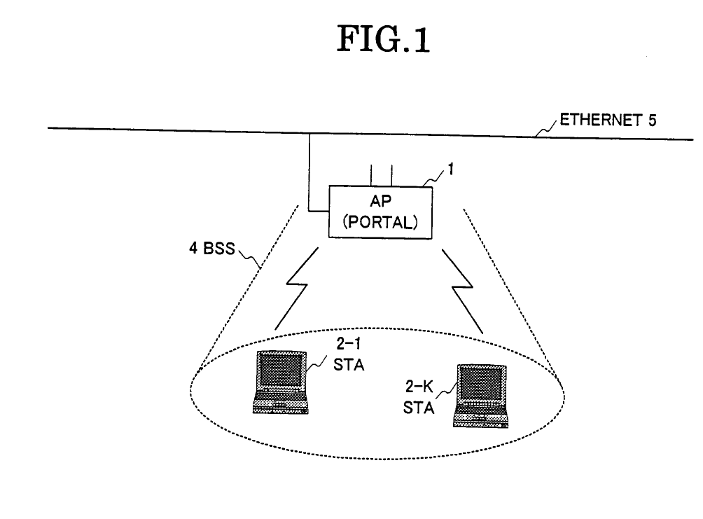

FIG. 1 is a block diagram showing an embodiment of the authentication system in a wireless LAN system according to the present invention.

The embodiment shown in FIG. 1 comprises an AP (access point) 1 as a wireless LAN base station 1 and a plurality of STAs (stations) 2 (i.e., STAs 2-1 to 2-k). This system is an infrastructure system defined in IEEE 802.11. The least unit of such wireless LAN network is called BSS (basic service set) 4.

As for each STA 2 in the BSS 4, the AP 1 makes periodic broadcast transmission of a beacon frame including data for synchronization to each STA 2 in the BSS 4. Each STA 2 in the BSS 4 which has received the pertinent beacon frame, makes an authentication request to the AP 1 at the time of starting communication, and after receiving authentication permission for the AP 1, it completes a process of making it to be belonging to the AP 1 so as to be ready for communication therewith. Also, each STA 2 in the BSS 4 in the infrastructure system makes communication between STAs 2 via the AP 1.

The AP 1 in FIG. 1 is also labeled “Portal”. By the term “portal” is meant that a function of protocol conversion to a LAN protocol other than in IEEE 802.11 is added to the AP 1, and the term thus means a base station, which permits connection of the AP 1 as base station to a wired LAN such as Ethernet 5.

While the embodiment shown in FIG. 1 conforms to IEEE 802.11, it adopts, unlike the shared key system (i.e., shared key authentication system), mainly an authentication system using both confidential key and public key as a system of encryption and authentication in a radio section. For the sake of distinguishing from the shared key system and also for the sake of brevity, the authentication system in this embodiment is called public key authentication system.

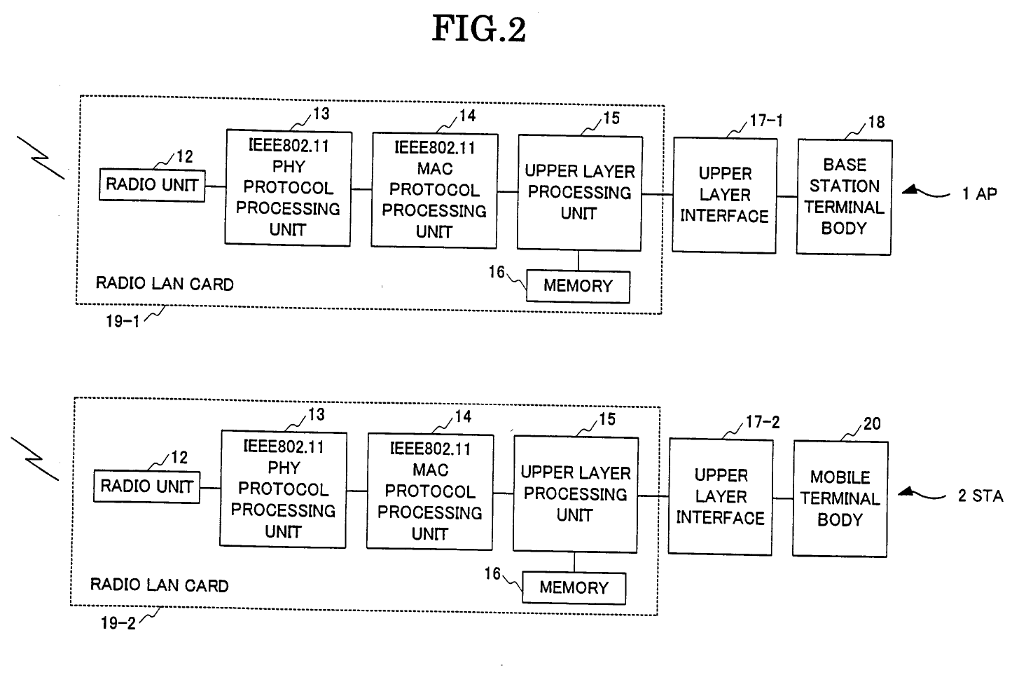

Now, the constructions of the AP 1 and STA 2 will now be described with reference to FIG. 2.

FIG. 2 is a detailed block diagram showing an example of the AP and STA.

In FIG. 2, the upper block diagram shows the AP 1, and the lower block diagram shows the STA 2.

In the AP 1, a base station terminal body 18 realizes upper protocol processes of TCP/IP (Transport Control Protocol/Internet Protocol) and various applications via an upper layer interface 17-1 as an interface between a wireless LAN card 19-1 as shown in FIG. 2 and an upper layer. In the STA 2, a mobile terminal station body 20 such as a note type personal computer, realizes upper protocol processes like those in the case of the AP 1 via an upper layer interface 17-2 as an interface between a wireless LAN card 19-2 as shown in FIG. 2 and an upper layer.

The wireless LAN cards 19-1 and 19-2 shown in FIG. 2 have the same construction. Thus, like elements in the wireless LAN cards 19-1 and 19-2 are designated by like reference numerals.

The wireless LAN cards 19-1 and 19-2 in FIG. 2 each includes a radio unit part 12 serving for frame transmission and reception in the radio frame, an IEEE 802.11 PHY (physical layer) protocol processing part 13 for executing modulating and demodulating processes, an IEEE 802.11 MAC (Medium Access Control) protocol processing part 14 for making access control in MAC layer, and an upper layer processing unit 15 for realizing such upper layer processes as authentication process in MAC layer built-in CPU and memory 16, the memory 16 being used by the upper layer processing part 15.

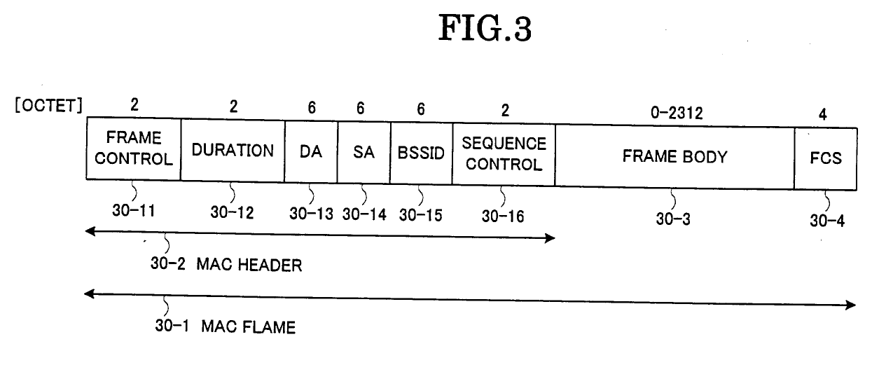

Now, an MAC frame which is transmitted and received between the STA 2 and the AP 1 when the STA 2 requires an authentication to the AP 1, will now be described with reference to FIG. 3.

FIG. 3 is a view showing the configuration of the MAC frame transmitted and received between the AP and the STA at the authentication request time.

At the time of authentication request from the STA 2 to the AP 1, an MAC frame 30-1 of an IEEE 802.11 MAC frame format as shown in FIG. 3, is transmitted and received between the AP 1 and the STA 2. The MAC frame 30-1 has an MAC header 30-2, a frame body 30-3 and an FCS (frame check sequence) 30-4.

The MAC header 30-2 in the infrastructure system has a field of frame control 30-11 showing various frame types and control data, a field of duration 30-12 defining a time of waiting for transmission when the destination is busy, a field DA (destination address) 30-13 indicating the frame transmission destination address, a field of SA (source address) 30-14 indicating the frame transmission source address, a field of BSSID 30-15 indicating discrimination data of the BSS 4, and a field of sequence control 30-16 indicating frame transmission sequence.

At the time of frame transmission, the IEEE 802.11 MAC protocol processing part 14 as shown in FIG. 2 executes frame conversion to the MAC frame 30-1 conforming to the IEEE 802.11 MAC protocol as shown in FIG. 3 by capsuling a transmission request frame from the upper layer processing part 15 in the frame body 30-3 as shown in FIG. 3, then inserting the MAC header 30-2 produced from transmission request data before the frame body 30-3 and then inserting the result of CBC 32 (cyclic redundancy code, 32 bits) computation with respect to the MAC header 30-2 and the frame body 30-3 as the FCS 30-4 after the frame body 30-3. Then, the IEEE 802.11 PHY protocol processing part 13 as shown in FIG. 2 executes a modulation process on the MAC frame 30-1. The modulation of the MAC frame 30-1 is then transmitted via the radio unit part 12 into air, thus completing the process of transmission.

At the time of frame reception, the IEEE 802.11 PHY protocol processing part 13 as shown in FIG. 2 executes a demodulating process on the output of the radio unit part 12. The IEEE 802.11 MAC protocol processing part 14 executes CRC 32 computation on the received MAC header 30-2 and frame body 30-3 inputted as the result of the demodulation. When the value of the FCS 30-4 in the received MAC frame and the result of the CRC 32 computation are identical, the part 14 executes analysis of the content of the MAC header 30-2 and process on the received MAC frame, and notifies the frame body 30-3 to the upper layer processing part 15.

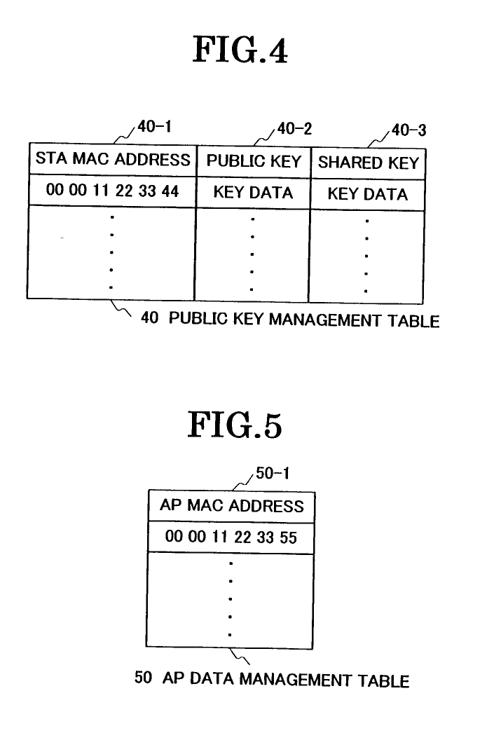

Now, a public key management table and an AP data management table, as important elements of the embodiment, will now be described with reference to FIGS. 4 and 5.

FIG. 4 is a view for explaining the public key management table held in the AP. FIG. 5 is a view for describing AP data management table held in the STA.

The AP 1 holds the public key management table 40 as shown in FIG. 4 in the memory 16 of the LAN card 19-1. The public key management table 40 consists of a column of STA MAC addresses (i.e., MAC addresses of STA), which are held in the AP 1 as physical addresses of MAC layer, i.e., MAC addresses, of STAs 2 having authentication permission result in the public key authentication according to the present invention, a column of public key 40-2, in which public keys of the pertinent STAs 2 are held, and a column of shared key 40-3, in which shared keys issued to the pertinent STAs 2 at the time of authentication permission are held. The AP 1 registers each line of the public key management table 40 in the order of newest authentication permission to STA 2.

The STA 2 holds the AP data management table 50 as shown in FIG. 5 in the memory 16 of the wireless LAN card 19-2 as shown in FIG. 2. The AP data management table 50 consists of a column of AP MAC addresses (i.e., MAC addresses of AP) 50-1, which are held in the STA 2 as MAC addresses in AP 1 corresponding to public key authentication completion results produced as requests of the public key authentication according to the present invention. The STA 2 registers each line of the AP data management table 50 in the order of newest authentication completion result produced by AP 1.

When the AP 1 registers data in the public key management table 40 as shown in FIG. 4, it retrieves the registered STA addresses 40-1. When the same MAC address having been registered is found, the AP 1 updates the registered data, and shifts the data to the forefront line in the public key management table 40. Also, whenever encryption frame communication after public key authentication completion according to the present invention is executed, the AP 1 retrieves the STA MAC addresses 40-1 and shifts the management data of the opposite side party STA 2 in communication to the forefront line of the public key management table 40. By positioning the management data of the opposite side party of the newer communication in the more upper rank part of the management table in the above way, it is possible, by removing the management data of the oldest opposite side party of communication in the lowest rank position in the pubic key management table 40, to cope with the case when registration of new data is no longer possible due to reaching of a limit number of registrations in the public key management table 40.

When the STA 2 registers data in the AP data management table 50 described before in connection with FIG. 5, like the AP 1 it retrieves the registered AP MAC addresses 50-1, and also when the same MAC address having been registered is found, it updates the registered data and shifts the data to the forefront line of the AP data management table 50. The STA 2 retrieves AP MAC address 50-1 of AP data management table 50 for each frame encryption communication, then positions the management data of the opposite side party of the newer communication in the more upper rank part of the management table as shown above. Thus, it is possible, by removing the management data of the oldest opposite side party of communication in the lowest rank position in the AP data management table 50, to cope with the case when registration of new data is no longer possible due to reaching of a limit number of registrations in the AP data management table 50.

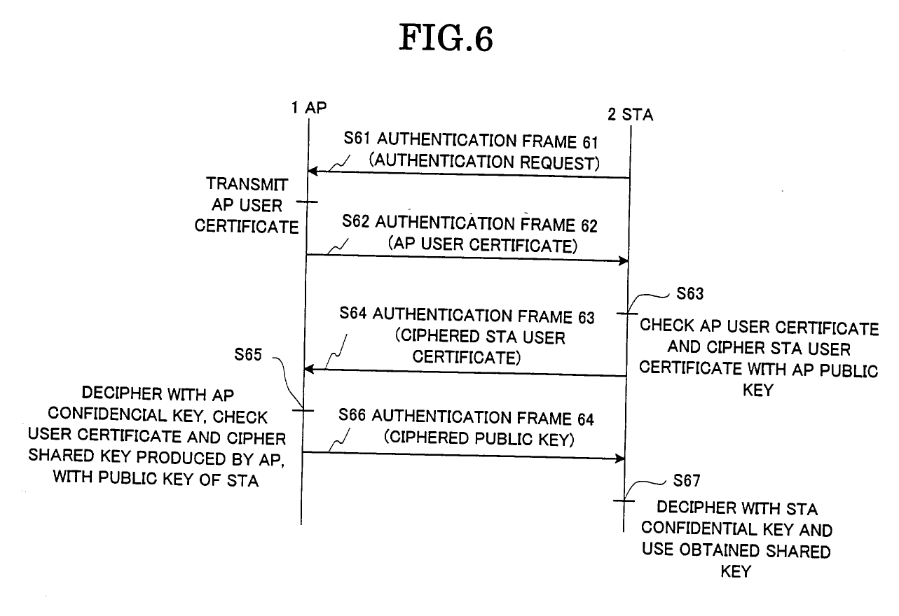

The operation of the embodiment will now be described with reference to FIGS. 6 to 9.

In this embodiment, it is assumed that the AP 1 as base station and each STA 2 as mobile terminal station in the wireless LAN system as shown in FIG. 1, both hold the own confidential keys, public keys corresponding thereto and user certificates with the public keys attached thereto. It is also assumed that the user certificate has a preamble that a third party represented by the authenticating organ can certify the relation between the public key and the owner thereof (i.e., the AP 1 or the STA 2) and further the legalness of the owner itself. It is further assumed that the user certificate means a digital user certificate.

Wireless communication between STAs 2 via the AP 1 as shown in FIG. 1, is started when the STA 2 transmits a request of the public key authentication according to the present invention to the AP 1.

At the public key authentication start, the STA 2 retrieves the AP MAC addresses 50-1 in the AP data management table 50 as shown in FIG. 5 by using the MAC address of the authentication request destination AP 1. When no MAC address of authentication request destination AP 1 is present in the AP data management table 50, the STA 2 executes the public key authentication procedure shown in FIG. 6 as the first authentication request. When an MAC address of authentication request destination AP 1 is present, this means that there is a past public key authentication completion result with respect to the pertinent AP 1. Thus, the STA 2 executes a public key re-authentication procedure as re-authentication.

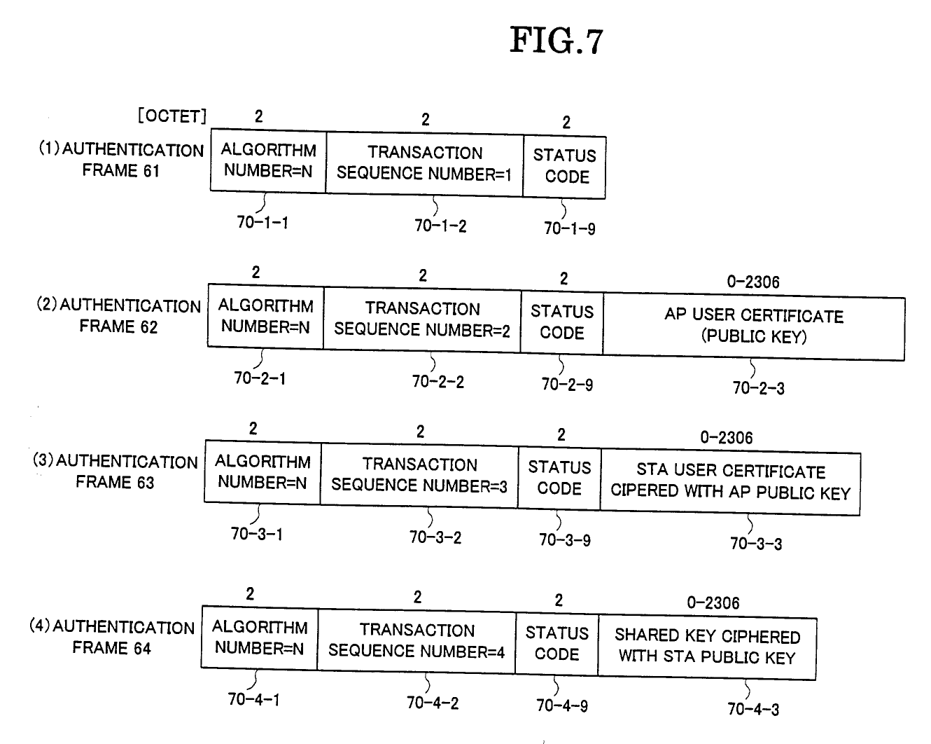

First, the public key authentication procedure as the first authentication request will be described with reference to FIGS. 6 and 7.

FIG. 6 is a view showing the public key authentication procedure. FIG. 7 is a view showing frame body part (i.e., frame body 30-3 as shown in FIG. 3) of the MAC frame transmitted and received in the public key authentication procedure.

Referring to FIG. 6, when the STA 2 requests authentication to the AP 1 by the public key authentication procedure, it transmits an authentication frame 61 to the AP 1 (step S61). The body frame part of the authentication frame 61 has a form of (1) authentication frame 61 as shown in FIG. 7, and is a frame with algorithm number 70-1-1 of “n” and also with transaction sequence number 70-1-2 of “1”. It is assumed that at the time of authentication by the public key authentication procedure the algorithm numbers 70-1-1 to 70-4-1 are always “n” (“n” being any number which is neither “0” nor “1”). With the algorithm numbers 70-1-1 to 70-4-1 set to “n”, it is possible to distinguish this authentication procedure from that based on the shared key system.

When the AP 1 receives the public key authentication request transmitted from the STA 2 in the step S61, it transmits the user certificate held therein to the STA 2 by using the authentication frame 62 (step S62). The authentication frame 62 has a form of (2) authentication frame 62 as shown in FIG. 7, and is a frame with algorithm number 70-2-1 of “n” as noted above, with transaction sequence number 70-2-2 of “2” and further with the user certificate held in the AP 1 (with attached public key of AP 1 belonging to the user certificate) inserted in the user certificate 70-2-3.

When the STA 2 receives the authentication frame 62 transmitted from the AP 1 in the step S62, it checks the content of the user certificate of the AP 1 received from the AP. When the STA 2 confirms that the check result the user certificate of the AP 1 has no problem, it ciphers the user certificate held in it by using the public key attached to the user certificate of the AP 1 (step S63). Then, the STA 2 transmits the ciphered user certificate thereof together with its public key belonging to its user certificate to the AP 1 by using the authentication frame 63 (step S64). The authentication frame 63 has a form of (3) authentication frame 63 as shown in FIG. 7, and is a frame with algorithm number 70-3-1 of “n” as noted above, with transaction sequence number 70-3-2 of “3” and further with added encryption STA user certificate 70-3-3 obtained as a result of ciphering with public key of AP.

When the AP 1 receives the authentication frame 63 transmitted in the step S64, it deciphers the encryption STA user certificate 70-3-3 obtained as a result of ciphering with publication key of AP with its confidential key, and checks the content of the user certificate of the STA 2. When the AP 1 confirms that the check result of the user certificate of the STA 2 has no problem, it produces shared key this time, and ciphers the shared key, which has been produced by using public key attached to the user certificate of the STA 2 (step S65). The AP 1 transmits the ciphered key to the STA 2 by using the authentication frame 64, and notifies authentication permission to the STA 2 (step S66). The authentication frame 64 has a form of (4) authentication frame 64 as shown in FIG. 7, and is a frame with algorithm number 70-4-1 of “n” as noted above, transaction sequence number 70-4-2 of “4” and further with added encryption shared key 70-4-3 obtained as a result of ciphering with public key of STA. The status codes 70-1-9 to 70-4-9 as shown in FIG. 7 are data fields for notifying the success or failure of frame reception or the like to the opposite side party of communication.

When the STA 2 subsequently receives the authentication frame 64 from the AP 1 in step S66, it deciphers the encryption shared key 70-4-3 obtained as a result of ciphering with public key of STA by using its confidential key, thus restores the shared key produced by the AP 1, and subsequently uses the restored shared key for frame encryption in actual wireless communication (step S67). In the operation as described above, the public key authentication procedure is completed, and subsequently encryption frame communication is made between the STA 2 and the AP 1.

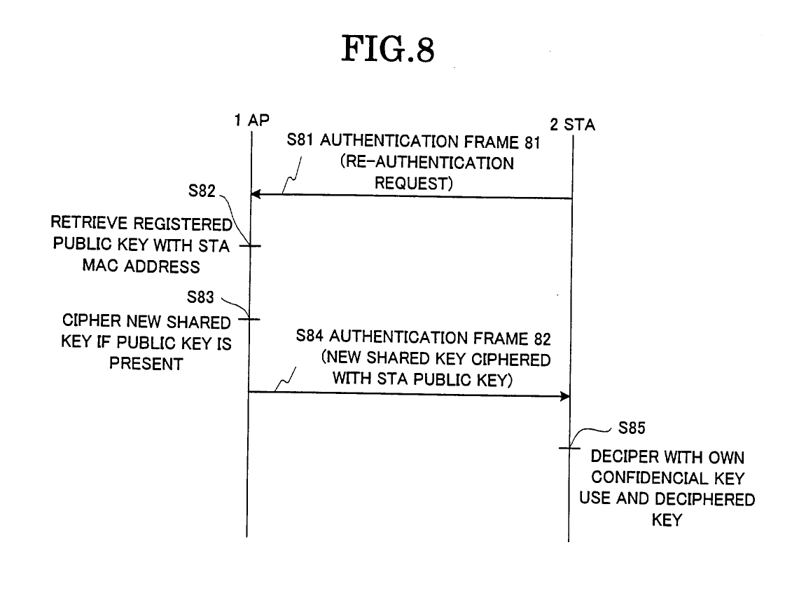

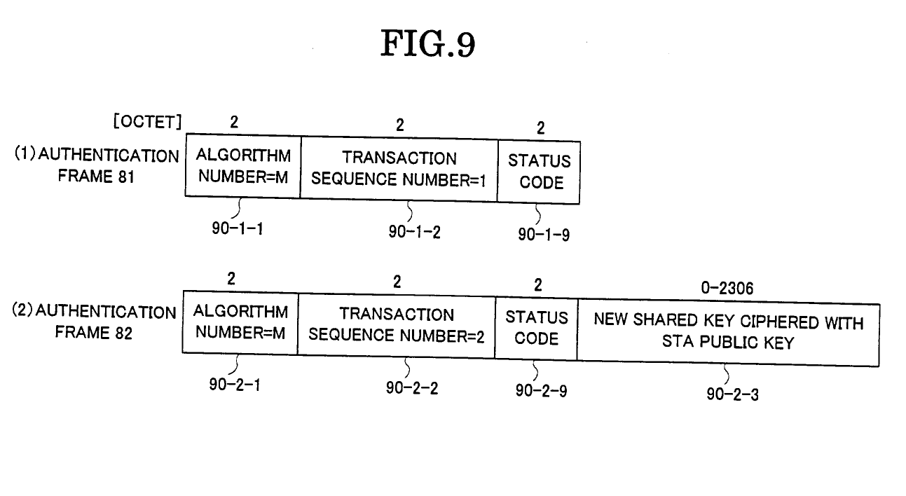

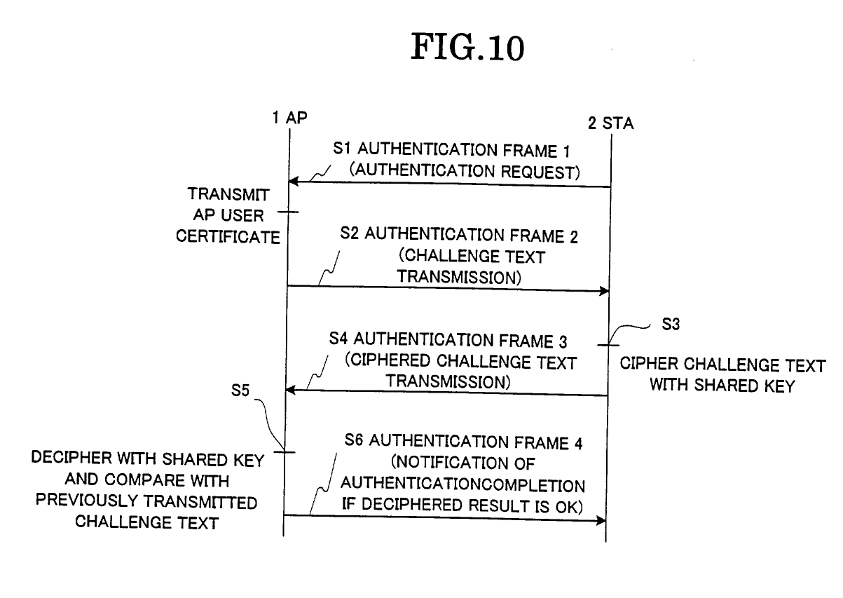

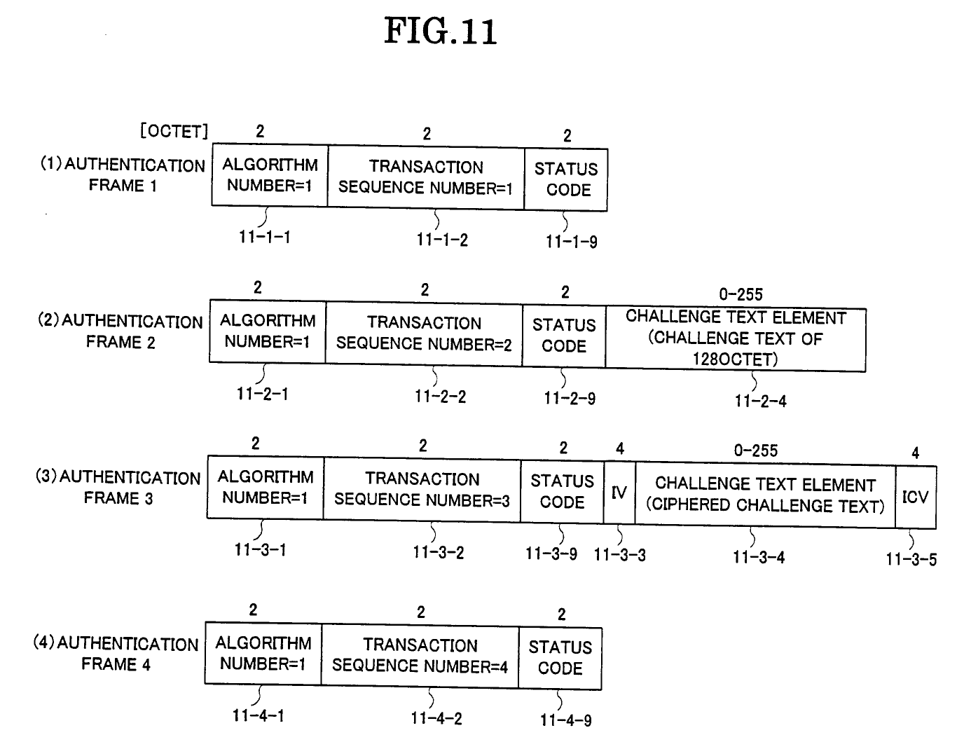

Now, the public key re-authentication procedure in re-authentication will be described with reference to FIGS. 8 and 9.

FIG. 8 is a view showing the re-authentication procedure. FIG. 9 is a view showing a frame body part (i.e., frame body 30-3 as shown in FIG. 3) of MAC frame transmitted and received in the public key re-authentication procedure.

Referring to FIG. 8, the STA 2 which has a past public key authentication completion result with respect to an authentication request destination AP 1, transmits an authentication frame 81 as public key re-authentication request to the AP 1 (step S81). The frame body part of the authentication frame 81 has a form of (1) authentication frame 81 as shown in FIG. 9, and is a frame with algorithm number 90-1-1 of “m” and with transaction sequence number 90-1-2 of “1”. It is assumed that at the time of authentication in the public key re-authentication procedure the algorithm number 90-1-1 to 90-2-1 are always “m” (“m” being any number other than “0”, “1” and “n”). With the algorithm numbers 90-1-1 to 90-2-1 of “m”, it is possible to distinguish the public key authentication procedure from the one as shown in FIG. 6.

When the AP 1 receives the public key re-authentication request transmitted from the STA 2 in the step S81, it retrieves the public key management table 40 as shown in FIG. 4 held by the AP 1 to check whether the MAC address of the STA 2 having transmitted the public key re-authentication request is present among the STA MAC addresses 40-1 (step S82). When the AP 1 succeeds in the retrieval and confirms that the corresponding public key is held in the column of public keys 40-2, the AP 1 newly produces a shared key designated for the pertinent STA 2, and ciphers this new shared key by using a public key obtained as one of the public keys 40-2 in the pubic key management table 40 (i.e., public key in the corresponding STA 2 (step S83). The AP 1 then transmits the ciphered new shared key to the STA 2 by using the authentication frame 82 (step S84). The authentication frame 82 has a format of (2) authentication frame 82 as shown in FIG. 9, and is a frame with algorithm number 90-2-1 of “m” as noted above, with transaction sequence number 90-2-2 of “2” and further with added ciphered new shared key 90-2-3 obtained as a result of ciphering with the STA public key. The status codes 90-1-9 and 90-2-9 as shown in FIG. 9 are data fields for notifying the success or failure of frame reception and so forth to the opposite side party of communication.

When the STA 2 receives the authentication frame 82 transmitted from the AP 1 in the step S84, deciphers the ciphered new shared key 90-2-3, obtained as a result of ciphering with the STA public key, with a confidential key held by it, the deciphered new shared key being used in frame encryption which is done in subsequent actual wireless communication (step S85). In the above operation, the public key re-authentication procedure is completed, and subsequently frame encryption communication is made between the STA 2 and the AP 1.

In the first embodiment of the present invention as has been described, the AP 1 and the STA 2 possess their respective confidential keys, public keys corresponding thereto and user certificates with public keys attached thereto. The STA 2 requests the public key authentication under the condition that the pertinent user certificate is such that a third party represented by authentication organ can certify the relation between the public key and the owner thereof and the legal ness of the owner itself. While the public key change procedure as shown in FIG. 6 takes place until obtaining the authentication permission from the AP 1, according to the present invention the AP 1 and the STA 2 continue to hold the public key data of the opposite side party having a authentication completion result even after voiding an existing authentication relationship, and when making the second and following authentication requests, the public key re-authentication procedure that was made between the AP 1 and the STA 2 in the first authentication procedure is omitted by using the public key re-authentication procedure as shown in FIG. 8. In this way, the procedure of the authentication process can be simplified.

Also, with the use of the user certificate in the first public key authentication procedure as shown in FIG. 6, the AP 1 holds the public key data of the STA 2 after issuance of the authentication permission by confirming the public key of the STA 2 and the legal ness of the STA 2 as the public key owner. Thus, even when an illegal re-authentication request is produced by using the MAC address of an STA 2, the AP1 executes the public key re-authentication procedure as shown in FIG. 8 by ciphering the shared key to be transmitted to the STA 2 with the public key corresponding to the confidential key which is possessed only by the legal, i.e., true, STA 2. Thus, the illegal re-authentication request source STA can not decipher and take out the shared key. It is thus possible to prevent unfair communication by illegal STA.

A second embodiment of the present invention will now be described.

The second embodiment is a wireless LAN system having such a constitution that, in a composite network, which a plurality of BSSs (basic service sets) constituted by a plurality of APs (base stations) belong to and wire or wireless inter-connected, public key management data (specifically, the public key management table 40 as shown in FIG. 4) of STAs (mobile station terminals) belonging to each AP are made to be common data in the composite network. The constitution in which the public key management data are made to be common data in the composite network, is such that an upper rank AP, for instance, for collectively managing a plurality of APS is provided for collectively holding public key management data and that each AP makes registration or inquiry to the upper rank AP when necessary and obtains an answer therefrom. With this constitution, when it becomes necessary for an STA belonging to a given AP, due to a BSS movement (change), to obtain a first public key authentication with respect to a different AP, the procedure of the authentication process can be simplified by executing the public key re-authentication procedure according to the present invention.

A third embodiment of the present invention will now be described.

The third embodiment is an application of the first embodiment of the present invention to a wireless LAN system of an independent system defined by IEEE 802.11. In the independent system, only a plurality of STAs are present in an IBSS (independent BSS), and no AP is present. At the time of the public key authentication request between STAs in the IBSS, on the basis of the first embodiment of the present invention the STA having received the public key authentication request continuously holds the public key management data of the authentication request source STA (specifically the public key management table 40 as shown in FIG. 4. This constitution has an effect that the second and following public key re-authentication process procedures can be simplified.

In the first to third embodiments of the present invention, by providing a term of holding the public key management data with introduction of effective term data based on the user certificate together with the public key management data concerning the authentication request source STA held by the AP for issuing the authentication permission in the BSS or the STA therein, it is possible to prevent continual use of a user certificate which is no longer in effective term.

As has been described in the foregoing, in the method of and system for authentication in a wireless LAN system according to the present invention, confidential encryption key distribution and authentication procedures can be realized at a time only between the opposite side parties of wireless communication. Thus, it is possible for the STA (mobile terminal station) having completed the first authentication to simplify the second and following authentication procedures with respect to the same AP (base station) after the authentication release.

Changes in construction will occur to those skilled in the art and various apparently different modifications and embodiments may be made without departing from the scope of the present invention. The matter set forth in the foregoing description and accompanying drawings is offered by way of illustration only. It is therefore intended that the foregoing description be regarded as illustrative rather than limiting.

What is claimed is:

1. An authentication method in a wireless LAN system, wherein an STA (mobile terminal station) retrieves an AP data management table held in the STA for checking whether the MAC address of an AP (base station), which the STA intends to make communication with, is present in the AP data management table, and when the MAC address is not present in the AP data management table, makes a public key authentication request to the AP, when the public key authentication request is proper, the AP effects authentication for the STA, when the MAC address is present in the AP data management table, the STA makes a public key re-authentication request to the AP, and when the public key re-authentication request is proper, the AP makes authentication of the STA.

2. The authentication method in a wireless LAN system according to claim 1, wherein in the AP data management table the STA holds MAC addresses of APs having public key authentication completion result in the order of newer authentication completion results by making public key authentication requests.

3. The authentication method in a wireless LAN system according to one of claims 1 and 2, wherein the AP holds an AP confidential key as its own confidential key, an AP public key as a public key corresponding to the AP confidential key and an AP user certificate as its own user certificate with the AP public key attached thereto, and the STA holds an STA confidential key as its own confidential key, an STA public key as a public key corresponding to the STA confidential key and an STA user certificate as its own user certificate with the STA public key attached thereto.

4. The authentication method in wireless LAN system according to claim 3, wherein the step of the public key authentication request from the STA to the AP is constituted by a public key authentication procedure, the public key authentication procedure comprising a step authentication request from the STA to the AP, a step of transmitting the AP user certificate from the AP having received the authentication request to the STA, a step, in which the STA having received the AP user certificate checks the AP user certificate, then produces a ciphered STA user certificate by ciphering the STA user certificate by using the AP public key attached to the AP user certificate and then transmits the ciphered STA user certificate, and a step, in which the AP having received the ciphered STA user certificate reproduces the STA user certificate by deciphering the ciphered STA user certificate with the AP confidential key, then checks the reproduced STA user certificate, then produces a ciphered shared key by ciphering the shared key produced by the AP by using the STA public key attached to the STA user certificate and notifying the authentication permission to the STA, wherein the STA having received the ciphered shared key reproduces the shared key by deciphering the ciphered shared key with the STA confidential key and uses the reproduced shared key for subsequent encryption frame transmission.

5. The authentication method in a wireless LAN system according to claim 4, wherein the algorithm number of a frame body part in the MAC frame that is transmitted and received when the STA requests the public key authentication to the AP is number “n” other than “0” and “1”.

6. The authentication method in a wireless LAN system according to claim 5, wherein the AP holds a public key management table, and in the public key management table MAC addresses of STAs which the AP has past authentication permission notification results to, the STA public keys of the STAs and shared keys which the AP has generated and issued at the time of authentication permission of the STAs are held in the order of newer authentication permissions.

7. The authentication method in a wireless LAN system according to claim 6, wherein the public key re-authentication request from the STA to the AP is a public key re-authentication procedure, the re-authentication procedure comprising a step, in which the STA makes a re-authentication request to the AP, and a step, in which the AP having received the re-authentication request retrieves the public key management table held in the AP to check whether the MAC address of the STA having transmitted the public key management request is present in the table, and when it is found as a result of the check that the MAC address of the STA is present in the public key management table and also that the STA public key as public key corresponding to the MAC address is held in the table, the AP generates a new shared key as a new shared key designated with respect to the STA, generates a ciphered new shared key by ciphering the new shared key with the STA public key and notifying authentication permission to the STA by transmitting the ciphered new shared key thereto, and the STA having received the ciphered new shared key reproduces the new shared key by deciphering the ciphered new shared key with the STA confidential key for using the new shared key for subsequent encryption frame communication.

8. The authentication method in a wireless LAN system according to claim 7, wherein the algorithm number of frame body part of the MAC frame received at the time the public key re-authentication request from the STA to the AP is a given number “m” other than “0”, “1” and “n”.

9. An authentication system in a wireless LAN system comprising, an STA (mobile terminal station) which retrieves an AP data management table held in the STA for checking whether the MAC address of an AP (base station), which the STA intends to make communication with, is present in the AP data management table, and when the MAC address is not present in the AP data management table, makes a public key authentication request to the AP, when the MAC address is present in the AP data management table, makes a public key re-authentication request to the AP, and the AP which makes authentication of the STA when the public key re-authentication request is proper.

10. The authentication system in a wireless LAN system according to claim 9, wherein in the AP data management table the STA holds MAC addresses of APs having public key authentication completion result in the order of newer authentication completion results by making public key authentication requests.

11. The authentication system in a wireless LAN system according to one of claims 9 and 10, wherein the AP holds an AP confidential key as its own confidential key, an AP public key as a public key corresponding to the AP confidential key and an AP user certificate as its own user certificate with the AP public key attached thereto, and the STA holds an STA confidential key as its own confidential key, an STA public key as a public key corresponding to the STA confidential key and an STA user certificate as its own user certificate with the STA public key attached thereto.

12. The authentication system in wireless LAN system according to claim 11, wherein in the step of the public key authentication request from the STA to the AP, an authentication request is made from the STA to the AP, the AP user certificate is transmitted from the AP having received the authentication request to the STA, the STA having received the AP user certificate checks the AP user certificate, then produces a ciphered STA user certificate by ciphering the STA user certificate by using the AP public key attached to the AP user certificate and then transmits the ciphered STA user certificate to the AP, the AP having received the ciphered STA user certificate reproduces the STA user certificate by deciphering the ciphered STA user certificate with the AP confidential key, then checks the reproduced STA user certificate, then produces a ciphered shared key by ciphering the shared key produced by the AP by using the STA public key attached to the STA user certificate and notifying the authentication permission to the STA, and the STA having received the ciphered shared key reproduces the shared key by deciphering the ciphered shared key with the STA confidential key and uses the reproduced shared key for subsequent encryption frame transmission.

13. The authentication system in a wireless LAN system according to claim 12, wherein the algorithm number of a frame body part in the MAC frame that is transmitted and received when the STA requests the public key authentication to the AP is number “n” other than “0” and “1”.

14. The authentication system in a wireless LAN system according to claim 13, wherein the AP holds a public key management table, and in the public key management table MAC addresses of STAs which the AP has past authentication permission notification results to, the STA public keys of the STAs and shared keys which the AP has generated and issued at the time of authentication permission of the STAs are held in the order of newer authentication permissions.

15. The authentication system in a wireless LAN system according to claim 14, wherein the public key re-authentication request from the STA to the AP is a public key re-authentication procedure, the re-authentication procedure comprising a step, in which the STA makes a re-authentication request to the AP, and a step, in which the AP having received the re-authentication request retrieves the public key management table held in the AP to check whether the MAC address of the STA having transmitted the public key management request is present in the table, and when it is found as a result of the check that the MAC address of the STA is present in the public key management table and also that the STA public key as public key corresponding to the MAC address is held in the table, the AP generates a new shared key as a new shared key designated with respect to the STA, generates a ciphered new shared key by ciphering the new shared key with the STA public key and notifying authentication permission to the STA by transmitting the ciphered new shared key thereto, and the STA having received the ciphered new shared key reproduces the new shared key by deciphering the ciphered new shared key with the STA confidential key for using the new shared key for subsequent encryption frame communication.

16. The authentication system in a wireless LAN system according to claim 15, wherein the algorithm number of a frame body part in the MAC frame that is transmitted and received when the STA requests the public key authentication to the AP is number “m” other than “0”, “1” and “n”.
